(19) United States
(12) Patent Application Publication
(10) Pub. No.: US 2017/0068776 A1
(43) Pub. Date: Mar. 9, 2017

(54) METHODS AND SYSTEMS FOR BIOLOGICAL SEQUENCE ALIGNMENT

(71) Applicant: ARC BIO, LLC, Cambridge, MA (US)

(72) Inventors: Ricardo Godinez-Moreno, Cambridge, MA (US); Alejandro Quiroz-Zarate, Cambridge, MA (US); Pablo G. Coste, Newton, MA (US); Roberto Olivares-Amaya, Somerville, MA (US); Thomas J. Watson, Jr., Auburndale, MA (US)

(21) Appl. No.: 15/123,281

(22) PCT Filed: Mar. 4, 2015
(86) PCT No.: PCT/US15/18819

§ 371 Date: Sep. 2, 2016

Related U.S. Application Data
(60) Provisional application No. 61/947,874, filed on Mar. 4, 2014.

(51) Int. Cl. G06F 19/12

(52) U.S. Cl. CPC G06F 19/12

(57) ABSTRACT

A method for transforming a plurality of random biological sequence data to an ordered biological data sequence, the method comprises reading a reference biological data sequence; generating a plurality of indexes based on the reference biological data sequence; generating a library, the library including the plurality of indexes; organizing the library into an associative array; reading the plurality of random biological sequence data; encoding the plurality of random biological sequence data; comparing the encoded plurality of random biological sequence data to the reference biological sequence; and aligning the encoded plurality of random biological sequence data to the reference biological sequence using an alignment algorithm to generate a plurality of alignment data.

### CROSS-REFERENCE TO RELATED APPLICATIONS

This application claims the benefit of U.S. Provisional Patent Application Ser. No. 61/947,874 filed on Mar. 4, 2014 and entitled “Methods and Systems for Biological Sequence Assembly”

### STATEMENT REGARDING FEDERALLY SPONSORED RESEARCH

Not Applicable

### BACKGROUND OF THE INVENTION

Biological sequencing is the process of determining the precise order of nucleotides within a biomolecule. For example, biomolecules can include DNA, RNA, mRNA, protein sequences and other biopolymers. The rapid development of sequencing methods and instruments has significantly advanced biological and medical research, and led to an increase in medical discoveries. This rapid development has led to biological sequencing being a critical tool for researchers and diagnosticians alike, in the medical field (e.g. personalized medicine, fertility screening, lifestyle choices, and health/lifespan predictions) as well as in fields such as forensic science, virology and systems biology.

This rapid development of sequencing methods and instruments over the last three decades has also resulted in high throughput sequencing technologies that have significantly improved the speed and precision of the analyzed sequences. This has resulted in researchers being able to collect massive quantities of high-precision data in very short times. However, processing of this data requires significant computing power to be able to be done quickly and accurately. Thus, multiple computers are often utilized to analyze data using parallel or distributed processing to simultaneously analyze thousands, millions or even billions of nucleotide sequences. While parallel and/or distributed processing can result in fast, precise sequencing results, the huge amount of data that must be processed and transmitted between the parallel or distributed computers can lead to inefficiencies in both the transmission of the data and the processing thereof. Similar issues exist for proteomic data generated from mass spectrometers. These files can be on the order of hundreds of gigabytes per sample and terabytes per run. This can result in inefficiencies in both the transmission of the data and the processing thereof. As new technologies continue to be devised to read genetic, epigenetic and proteomic data, this problem will be further compounded.

### SUMMARY OF THE INVENTION

The present invention overcomes the aforementioned drawbacks by providing methods and systems for data processing, including sequence alignment using one or more processing devices.

Specifically, and in accordance with one aspect of the present invention, a method for transforming a plurality of random biological sequence data to an ordered biological data sequences is provided. The method comprises the steps of: reading a reference biological data sequence; generating a plurality of indexes based on the reference biological data sequence; generating a library, the library including the plurality of indexes; organizing the library into an associative array; reading the plurality of random biological sequence data; encoding the plurality of random biological sequence data; comparing the encoded plurality of random biological sequence data to the reference biological sequence; and aligning the encoded plurality of random biological sequence data to the reference biological sequence using an alignment algorithm to generate a plurality of alignment data.

In accordance with another aspect of the present invention, a system for aligning biological sequencing data using a reference biological sequence is provided. The system comprises a processing device, the processing device configured to perform executable instruction. The system further comprises a reader device, the reader device coupled to a sequencing device and configured to read a plurality of data received from the sequencing device. The device further still comprises a quality controller, the quality controller configured to generate one or more parameters indicative of a quality of the plurality of data received from the sequencing device. The device additionally comprises a converter, the converter configured to transmute the received data into numerical representations; and an aligner, the aligner configured to align the plurality of data received from the sequencing device into a single biological sequence using a reference biological sequence.

In accordance with yet another aspect of the present invention, a method for transforming a plurality of random biological sequence data to an ordered biological data sequence using a known reference biological sequence in a first processing device using parallel processing is provided. The method comprises: reading the plurality of random biological sequence data, the plurality of random biological sequencing data received from a sequencing device; analyzing the plurality of random biological sequence data and dividing the plurality of random biological sequence data into multiple data portions; transmitting at least a first portion of the plurality of random biological sequence data to a second processing device; aligning a second portion of the plurality of random biological sequence data to the reference biological sequence using an alignment algorithm to generate a first plurality of alignment data, the first processing device performing the alignment; receiving a second plurality of alignment data from the second processing device; and merging the first plurality of alignment data and the second plurality of alignment data into a sorted order corresponding to the locations of the first plurality of alignment data and the second plurality of alignment data with respect to the reference genome.

The foregoing and other aspects and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### BRIEF DESCRIPTION OF THE DRAWINGS

FIG. 1 is a system view of a data processing system for processing biological data.

FIG. 2 is a flow chart showing an embodiment of a sequence alignment process.

FIG. 3 is an illustrative view showing a masking function of a reference genome.

FIG. 4 is a flow chart showing a representation of a single machine alignment with post-sorting process.

FIG. 5 illustrates an example read data comparison process.

FIG. 6 is a flow chart showing a representation of a single machine alignment with pre-sorting process.

FIG. 7 is a flow chart showing a representation of a fast route single machine alignment with post-sorting process.

FIG. 8 is a flow chart showing a representation of a fast route single machine alignment with pre-sorting process.

FIG. 9 is a flow chart showing a representation of a remote genome aligner with post-sorting process.

FIG. 10 is a flow chart showing a representation of a remote genome alignment with pre-sorting process.

FIG. 11 is a flow chart showing a representation of a fast route genome alignment with post-sorting process.

FIG. 12 is a flow chart showing a representation of a fast route alignment with pre-sorting process.

### DETAILED DESCRIPTION OF THE INVENTION

As discussed, it is common when analyzing biological molecules such as DNA, RNA, etc. to use a device commonly known as a sequencer in order to extract biological molecule sequence information from a sample containing the biological molecules. Additionally, protein sequencing devices can determine the amino acid/residue sequences of the proteins using mass spectrometry. Further, other methods of analyzing biological molecules such as sample preparation techniques or software, can, for example, determine DNA modifications, histone positioning, and protein modifications including histone modification (e.g. acetylation, methylation, ubiquitylation, proponylation, etc.). RNA sequencing techniques can also be used to analyze biological molecules. RNA sequencing can measure gene expression by the alignment of the sequencing strings or reads to the reference genome. The larger the overlap of the alignment between the sequencing strings or reads to the reference genome can result in a higher level of gene expression. For purposes of this specification, RNA sequencing will be said to be done by an RNA sequencer. A common type of sequencer is a DNA sequencer. While reference is made in this application to “DNA sequencers,” it should be understood that the disclosed DNA sequencers could be any type of biological molecule sequencer, capable of sequencing biological molecules, such as DNA, RNA, modified genetic material, protein, etc.

DNA sequencers are specialized scientific analysis instruments that work to automate the process of sequencing DNA. Specifically, DNA sequencers are used to determine the order of the four nucleobases found in DNA: adenine (A), guanine (G), cytosine (C) and thymine (T). The DNA sequencer can report the results of its analysis in a string consisting of the letters, or nucleobases, A, G, C and T organized in base pairs, which illustrate the DNA sequence of the sampled biological sample. Additionally, other bases can exist in simple life forms and in certain mammals at lower frequencies than A, C, G, T (e.g. uridine, 5-methyl-cytosine, 3-methylcytosine, 1-methylguanine, 7-methylguanine, N2-methylguanine, and N2-dimethylguanine, hydroxlated bases and covalently attached amino acids and multiply hexosylated side chains such as beta-D-glucosyl-hyroxymethyluracil). These elements can also be sequenced using sequencers. The final output of the sequencer can be organized and printed in a file that consists of a set of sequence strings of fixed length, which can contain a tremendous amount of data. For example, the human genome contains approximately 3 billion base pairs. In some examples, a sequencing device can produce a data output that is multiples times larger than 3 billion base pairs. These strings, after being sequenced, can then be analyzed in order to evaluate genomic entities, such as genes, transcription factors, etc. that are made up of groups of the base pairs. This analysis can be performed by a high-powered computer, or via multiple computers in parallel of distributed configurations. Parallel and/or distributed processing across multiple computers or computing devices can allow the analysis to be performed quickly, without the need for a high performance computer, such as a supercomputer or other similar parallel computing platform.

In the instance of a distributed protocol, security measures must be taken into account with the input biological sequence data. These security measures are of paramount importance due to the sensitive nature of the data, and the effects of unauthorized access to this data is unquantifiable. Biological sequence data, including genomic information of an individual, cannot only contain personal identifying information of the individual, but it can also characterize personal identifying information of the individuals descendants, thereby jeopardizing their private personal information. This can lead to health insurance biases, job application refusals, and many adverse effects. Thus, the below systems and methods address security measures by providing adequate measures of encryption in key places of the distributed protocol. During the transmission process the data can be encrypted at a sequencing device, such as those discussed below. Encryption of the input biological sequence data can be done using multiple types of encryption technology. In one example, the encryption can be performed using a one time pad cipher for encryption. Additional, non-limiting examples of encryption methods can include cryptographically secure pseudorandom number generators, information-theoretically secure algorithms, integer factorization algorithms, primality tests, advanced access content systems, symmetric key algorithms, broken cryptography algorithms, cryptanalytic algorithms, and cryptographic hash functions. Furthermore, the encryption methods can utilize key pair concepts that utilize a public key, private key and/or passphrase (similar to that used in secure e-mail transfer). For example, the encrypting analysis device would need to have the public key of the intended recipient device. Similarly, the intended recipient device would also have to have the public key of the encrypting analysis device. Alternatively, a keyed-hash message authentication code (HMAC) can also be used to generate a message authentication code using a cryptographic hash function in combination with a secret cryptographic key. This message authentication code can be used to verify both data integrity as well as to authenticate the sequence or data being transmitted. When encryption keys are used for sending and receiving sequence data, the keys can be generated randomly and can contain sufficient entropy. Entropy can be derived from unpredictable computer operations, for example, the movement of a disk drive head.

The below terms are discussed below to illustrate preferred meanings of the terms as used in this specification.

As used herein, the term “alignment” can be any computational process in which every sequence strings of fixed length produced by a sequencer is matched to a reference string with known structure. Further, the term “assembly” can be any computational process in which every sequence string of fixed length produced by a sequencer are merged between one another with the objective to reconstruct the whole original sequence string, from which the set of all sequence strings were derived. The term “remote alignment” can be any computational process by which the alignment is divided into a certain predefined number of independent subtasks and for which each subtask is performed by an independent computer device capable of receiving the sequence strings, of aligning the sequence strings and of transmitting the sequence strings to the appropriate computational device of providing the final whole and complete alignment of all the subtasks.

Furthermore, the term “index” can by any database that is used to optimize the access of data. The database can consists of keys. These keys can be attributes on which the search on the original database is going to be based. The term “hash table” can describe a method or structure that can allow for accelerated searching within the index. The term “reference sequence” can refer to a sequence string composed of all the information required to define the molecule at hand. For example, a whole human genome would be a sequence string of nucleotides consisting of about 3 billion bases to be compliant for the definition of a human genome. The term “metadata: describes the composition of different types structures added in an ordered manner that can be consistent.

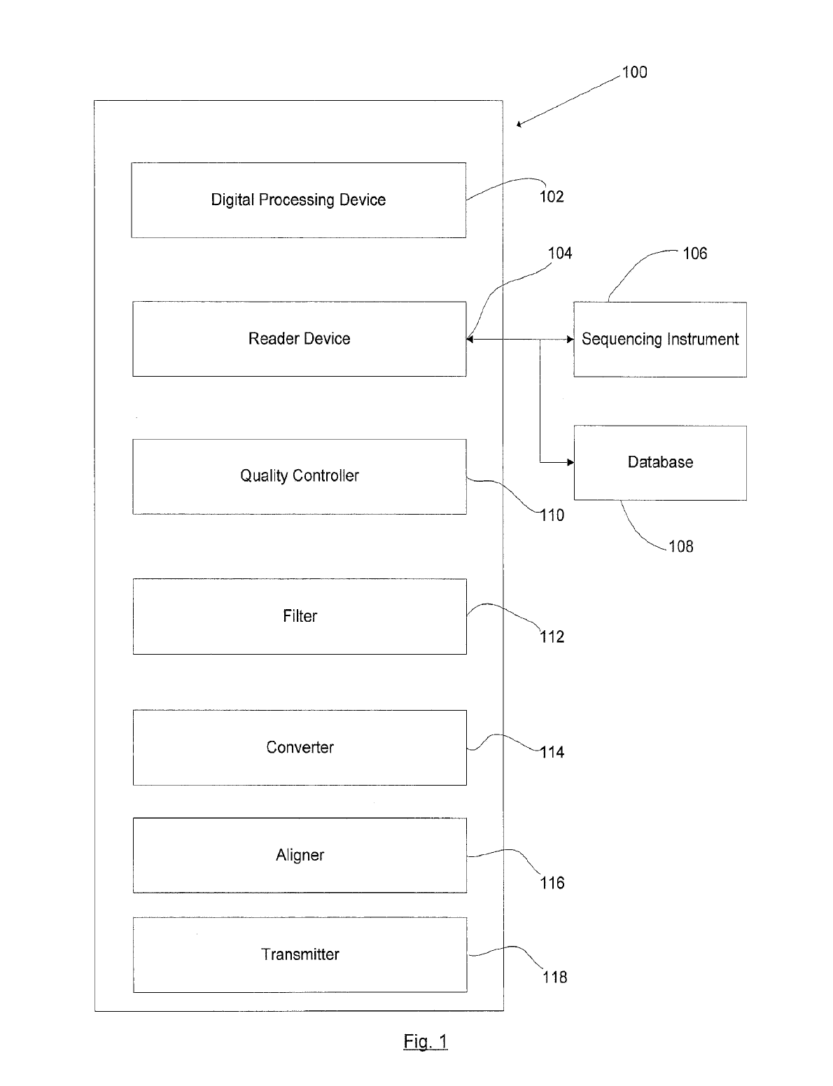

FIG. 1 illustrates a data-processing system 100 for processing biological data. The data processing system 100 can have a digital processing device 102 for performing data processing functions. For example, the digital processing device 102 can be configured to perform executable instructions. In one embodiment, the digital processing device 102 can include an operating system configured to execute instructions from a memory device. The digital processing device 102 can be a computer, such as Windows® based personal computers (PC) and portable device, Apple® Macintosh® desktop and portable devices, Linux-based machines or any other type of computer that can run the necessary analysis. Additionally, the digital processing device 102 could also include smartphones and/or other handheld devices and platforms. The digital processing device 102 could also be a dedicated single or multi-core processor, such as an Intel® based processor. The digital processing device 102 can also be a graphical processor or GPU such as an nVIDIA® based processors. Further, the digital processing device 102 could be a dedicated processing device such as a Application Specific Integrated Circuit (ASIC), Field Programmable Gate Array (FPGA), or any combination of the aforementioned processing devices.

The data processing system 100 can further include a reader device 104. The reader device 104 can be coupled to a sequencing instrument 106 to read one or more sets of biological data output from the sequencing instrument 106. The data processing system can include multiple reader devices coupled to each sequencing instrument 106 to read one or more sets of biological data output from the sequencing instrument 106. In one embodiment, the sets of biological data output from the sequencing instrument 106 can contain read data and quality data. Read data can be a subset of the sequence of base nucleotides comprising an organism's DNA. Quality data can be an experimental quality measure of each base nucleotide corresponding to the read data. Alternatively, the sets of biological data output from the sequencing device 106 can contain additional data such as metadata, This metadata can include details on an individual, groups of individuals, library data applied during data ingestion, experimental conditions, including that of the apparatus that generated the read data and the quality data. For example, an apparatus (e.g. sequencing device) that can generate read data and quality data. The reader device 104 can process the sets of biological data output from the sequencing instrument in a plurality of formats containing data. Non-limiting examples of formats readable by the reader device 104 can include BCL (with demultiplexing if needed), FASTQ, SAM, BAM, sequencing image files, binary, plain text, HDF5, BAM+BAI, etc. In one embodiment, the sequencing instrument can be a DNA sequencer. However, it should be known that the sequencer could be any type of biological molecule sequencer, such as an RNA sequencer platform. Non-limiting examples of types of sequencing instruments 106 can include single-molecule real-time sequencing, ion semiconductor, pyrosequencing, sequencing by synthesis, sequencing by ligation, and chain termination. The sequencing instrument 106 can analyze a biological sample and sequence nucleotides within the sample. Once the sequencing instrument 106 platform has completely sequenced the biological sample, the resulting data can be read by the reader device 104. The reader device 104 can be a single reader device, or can include multiple reader devices. In one embodiment, the reader device 104 can be connected directly to the sequencing instrument 106, through an onboard computing device on the sequencing instrument 106. Alternatively, the reader device 104 can be connected to the sequencing instrument 106 via a local area network (LAN). LANs can provide connections speeds of up to 100 Gbps. The reader device 104 can also be connected to the sequencing instrument 106 using various other connection methods, including a wide area network (WAN), fiber optics, Ethernet, wireless, satellite, or cell phone connections. Additionally, communication protocols such as UDP, TCP, or a combination of these technologies can be used to provide communication between the reading device 104 and the sequencing instrument 106.

Additionally, the reader device 104 can also be coupled to a database 108. The database 108 can store biological sequencing data, medical records, personal identifying information, population relevant information, etc. In one example, biological data variants can be stored in the database 108. Biological variant data can include information for determining the risk of carrying certain diseases, or for reconstructing or inferring a persons genetic lineage. The database 108 can store biological sequencing data generated by multiple sequencing instruments 106. Additionally, the database 108 can also store locations in biological data of biological diversity, such as known variant sites and locations. Different sequencing instruments 106 can format sequencing data differently; thus, in one embodiment, the reader device 104 can include an element that can read and transform multiple biological sequencing data formats into a format readable by the data processing system 100. Examples of data formats can include BCL (with “demultiplexing”), FASTQ, SAM, BAM, etc. Additionally, the sequencing instruments 106 can further work to compress and decompress data.

The data processing system 100 can further include a quality controller 108. Quality controller 110 can evaluate the quality of one or more biological sequences received by the reader device 104. In one embodiment, the quality controller 110 can generate one or more parameters indicative of a quality of the one or more biological sequences received by the reader device 104. In one embodiment, each base in a biological sequence can include a quality score. The quality controller 108 can evaluate the quality score associated with the base against a predetermined value. The quality controller 110 can remove bases with quality scores below the predetermined value. In one example, the quality controller 110 can average the quality scores across the entire read to determine the level of noise in the read sequencing data. Moreover, the quality controller 110 can trim the read sequencing data to improve the average quality score for a given read. The quality controller 110 can additionally reject a whole sequence string or read where it determines that the level of noise in the string or read dominates the clear data. Further, any ambiguous bases (i.e., N-bases) can automatically be rejected by the quality controller. In one embodiment, the quality controller 110 can utilize a statistical analysis to summarize the quality of the one or more biological sequences.

In a further embodiment, reliable portions of the one or more biological sequences can be determined by the quality controller 110. Alternatively, the length of reliable portions of the biological sequences can be determined by the quality controller 112. In one embodiment, reliable portions of the biological sequence can be those portions having quality scores above a predetermined value. Additionally, reliable portions of the biological data can be those having an integrity level sufficient to indicate a high quality level as determined using statistical analysis. In further examples, the quality controller 110 can evaluate the error rates within the biological sequences. Furthermore, in some embodiments, the quality controller 110 can retain the good quality sequences and discard the low quality sequences. In one embodiment, low quality sequences can be determined based on the on the currently adopted protocol of Phred Scores, where quality scores of 20 or less on a log scale are discarded. In some examples, quality scores of 35 or less can be discarded, or any quality score threshold that is determined. Alternatively, other protocols that can define different thresholds based on available quality metrics employed by the sequencing instrument 106 can also be used.

The data processing system 100 can additionally include a filter 112. In one embodiment, the filter 112 can be an index of an entire known reference biological sequence. Alternatively, the filter 112 can be a tree of reference sequences that are known to be different at positions in the genome. Additionally, due to the repetitive nature of biological sequences, the filter 112 can identify and remove redundant segments in biological sequences. In one embodiment, the filter 112 can scan a reference biological sequence by applying a fixed sequence of base nucleotides, (e.g. k-mers), and tabulating the occurrence and location of these k-mers in the reference biological sequences. The k-mers of the reference biological sequences can overlap by as much as all but a single base in the reference biological sequence, or two-bases, or three-bases, and so on. Alternatively, there may be no overlap at all. Redundancy can be removed by analyzing which k-mers have an equivalent sequence located in a different location within the reference biological sequence. In one embodiment the filter 112, can store CALs, Read IDs, FASTQ/BCL/INPUT line numbers, etc., in a memory. In one embodiment, the filter can store the biological sequencing data to a memory and extract CALs Additionally, the filter 112 can store Read IDs and input line numbers where the CALs have been found and the biological sequencing data is stored in the memory. In one embodiment, the filter 112 can remove duplicate portions of the biological sequencing data where the duplicate portions have the same CAL and read ID.

Moreover, the filter 112 can align the biological sequencing data in order from the beginning. In one embodiment, the filter 112 can align the biological sequencing data after the duplicate sequencing data has been removed. In one embodiment, the filter 112 can perform the filtering tasks in parallel. In one example, the filter 112 can remove noise in the biological sequences through the use of ascertained quality metrics either from the sequencing platform and/or with specific statistical models.

Furthermore, the data processing system 100 can include a converter 114. The converter 114 can transmute biological sequences, k-mers or reads to numerical representations. Biological sequence data can be expressed as alphabetical characters. In one embodiment, the converter 114 can convert the biological sequence data into numerical representations using base-2 numbering. Alternatively, the converter 114 can convert the biological sequence data into numerical representations using a base-4. Further, the converter 114 can convert the biological sequence data into numerical representations using a base-8, base-10, or other numbering system, as needed. The converter 114 can convert the biological sequence data into alphanumeric characters, in some examples. In one embodiment, the converter 114 can convert the biological sequences after they have been processed by the quality controller 110. Alternatively, the converter 114 can convert the biological sequences after they have been processed by the filter 112. The conversion process utilized by the converter 114 will be discussed in more detail below.

The data processing system 100 further includes an aligner 116. The aligner 116 can align the biological sequences into a single, larger biological entity, such as a genome, RNA sequences, a transcriptome, or a proteome. In one embodiment, the aligner 116 can assemble the biological sequences by analyzing the numerical values of the biological sequence lists of k-mers and comparing the k-mers to an index of reference biological sequences. Furthermore, where large volumes of biological sequences are received from the sequencing instrument 104, the aligner 114 can utilize a parallel processing method to assemble the biological sequences. The parallel processing can be performed using an individual computing device. Alternatively, the parallel processing can be performed on multiple computing devices located in multiple locations. Non-limiting examples of computing devices can include Windows® based personal computers (PC) and portable devices, Apple® Macintosh® desktop and portable devices, Linux-based machines or any other type of computer that is capable of running the necessary analysis.

In some embodiments, the aligner 114 can utilize an optimization algorithm to achieve optimum assembly times and/or accuracy. For example, the aligner 114 can use an optimization algorithm such as a BLAT-like Fast Accurate Search Tool (BFAST) algorithm to align biological sequences. An optimization algorithm can take advantage of available hardware elements to accelerate assembly time.

Furthermore, in some embodiments, the aligner can establish a generic data format to represent the biological sequences. This can allow the aligner 114 to produce a universal data format to represent biological sequences regardless of the data format of the raw biological sequences received by the reader device 104. The universal data format can be used to facilitate future uses and analysis of the biological sequences. Additionally the aligner 114 can produce a directory structure for efficient compression of biological data. In one embodiment, established standards can be used to structure the sequence data. As a non-limiting example, standards such as SAM, BAM, VCF, etc. can be used.

The directory structure can store data in separate files. In one embodiment, the directory structure can store sequencing data, aligned sequence data, and variant calling data in separate files. In one example, where FASTQ data files are used, the directory can include the ID, sequencing data and quality information. Alternatively, in the case of aligned data, for example SAM format files, the directory can include sequencing data quality data, offset data, CIGAR scores and other fields and flags. In a variant data format, the directory can include VCF data where VCF data contains the known locations of biological sequence variation contained in the biological sequences extracted from the DNA/RNA/etc sequencing machines, chromosome information, position information, ID, reference data, alternate bases, quality filter, additional information, and other flags. The separate files can all reside within a single directory structure. A control file can be used to properly index the data stored in the directory. Proper indexing can allow for efficient access to random-access of the data. Furthermore, the above data formats can be employed on storage devices such as hard-disk drives, flash solid state drives, or even in random access memory. The data can be accessed in a parallel nature, with each thread of execution pointing to certain parts of an output file. Alternatively, each thread of execution can point to different files located in the directory structure and accumulating the I/O results in a fast memory to perform more analysis on a set of alignment results.

The aligner 114 can write the assembled data to a variety of storage devices. For example, the aligner 114 can write the data to a separate storage device from where the un-assembled biological data is stored. Alternatively, the aligner 114 can write the data to the same storage device that the un-assembled data is stored. Furthermore, the aligner 114 can write and/or read data from storage devices such as hard disks, solid state hard drives, flash storage devices, flash memory devices, etc.

In some embodiments, the data processing system 100 can include a transmitter 118. The transmitter 118 can allow for the data processing system 100 to transmit the assembled biological entities to other devices. The transmitter 118 can include a compression module for compressing the biological entity. Furthermore, the transmitter can encode and/or encrypt the genome.

When assembling two or more sequences, portions of the sequences, such as the ends, can overlap. Where two or more sequences have overlapping portions, a sequence alignment process can be used to trim the redundant portion. Sequence alignment process can be performed by the aligner 114. Alternatively, the sequence alignment process can be performed by an independent component.

The data processing system 100 described above can be implemented using hardware, software or a combination of hardware and software modules. Further, the data processing system 100 can be implemented on a single device. Alternatively, the data processing system 100 can be implemented across multiple devices, where the biological data to be processed can be securely transmitted and distributed across multiple devices.

In one embodiment the data processing system 100 can be connected to a computer network. For example, the data processing system 100 can be connected to a network such as the Internet, allowing access to the World Wide Web. In still further embodiments, the data processing device 100 can be connected to a cloud computing infrastructure. The data processing device 100 can further be connected to an intranet type network, an internet type network, universal serial bus, firewire, fiber optic, high-speed earth to satellite to earth communication, Wi-Fi, Bluetooth, cellular (CDMA, GSA, 3G, 4G, LTE), radio frequency or any other type of communication technology capable of transmitting and receiving the sequencing data. In other embodiments, the data processing device 100 can be connected to a data storage device. In one embodiment, the data processing device 100 can be connected to a volatile type storage device, such as RAM. Connecting the data processing device 100 to a volatile type storage device provides a potential security feature. Power loss to the system, or unanticipated disruption as a result of a malicious cyber attack or intrusive activity can result in data stored in the volatile memory to be deleted. In some embodiments, the data processing device 100 can contain multiple central processing units (CPUs) with which to further distribute input biological sequences locally for alignment. Additionally, locally distributed workload can be loaded on a graphic processing unit (GPU) of the data processing device 100 that can allow for highly scalable local parallel processing. Furthermore, the data processing device 100 can have flash persistent storage devices which can load pre-computed indexes/filter in to a memory for I/O acceleration. The data processing device 100 can further read an input biological sequence from a hard disk or another (or even the same) flash persistent memory and use the CPU, CPUs, GPUs, or combination thereof to align the input biological sequences to the reference biological sequences. In other examples, FPGAs can be employed on PCI/e-express cards to read input and reference biological sequences. The FPGA's can read input biological sequences and reference biological sequences faster than traditional hard disks and can be further programmed with additional functionality to align the input data sequences.

In some embodiments, the data processing device 100 can include a display for providing visual information to a user. Additionally, the data processing device 100 can include an input device for receiving information or commands from a user. The input device can be a keyboard, mouse, trackball, track pad, joystick, game controller, stylus, or other input device that can allow a user to provide information to the data processing device 100. In some embodiments, the input device can be a touch screen or multiple touch-screens. The input device can further be a microphone or video camera to facilitate the use of verbal or physical actions by a user to manipulate the device.

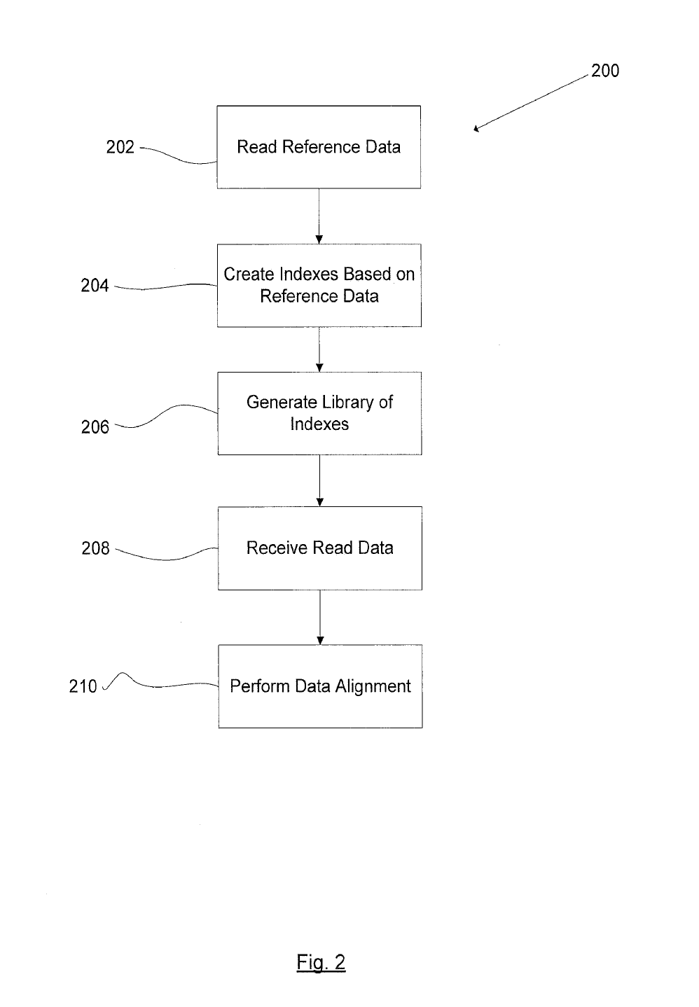

Turning now to FIG. 2, an exemplary embodiment of a sequence alignment process 200 can be seen. The sequence alignment process 200 can first read the reference biological sequences, such as a reference genome, at process block 202 into a memory. Once the reference genome has been read, the sequence alignment process 200 can create indexes based on the reference genome at process block 204. In one embodiment, the reference genome can be indexed using a masking function of fixed or variable length. In one embodiment, the masking function can be a gapped masking function. However, alternative masking functions, such as non-gapped masking functions can also be used. The width or length of the masking function applied to the biological sequences can define a k-mer corresponding to the length or width of the masking function. In one embodiment, the mask length can be the same length as the read. Where physical memory is not sufficient to store this amount of data, the data subsets (i.e. k-mers) can be converted to a base-4 number instead of series of data strings. This can conserve memory space by reducing the lengths of the data to be stored.

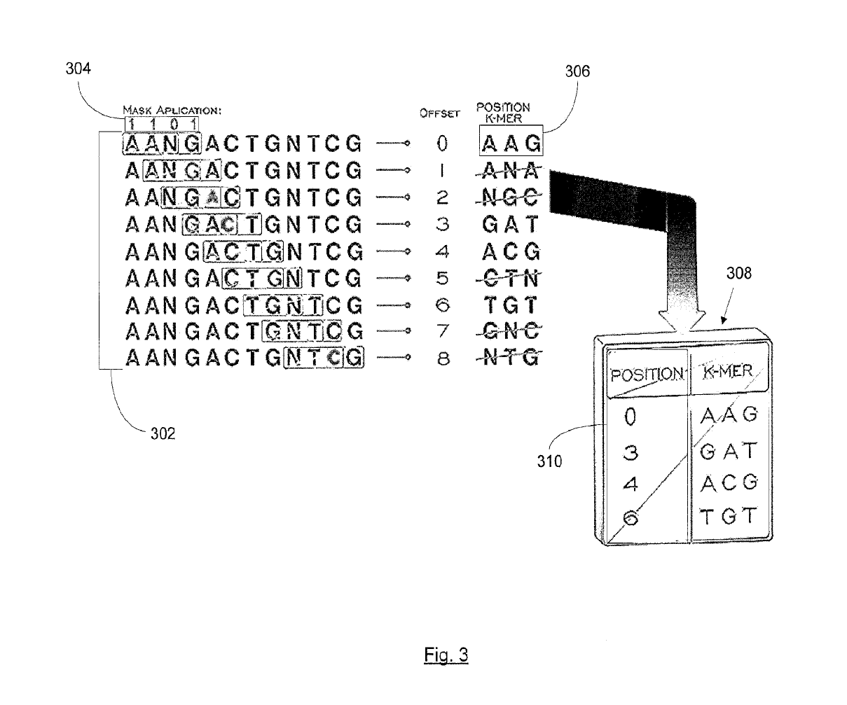

An exemplary masking function can be seen in FIG. 3. In FIG. 3, a reference genome 302 can be seen consisting of the elements AANGACTGNTCG. In this example, N represents unknown nucleotides. Additionally in this example, the mask 304 has a length of 4 and defines k-mers of length 3, the k-mer being comprised of all the elements corresponding to a 1 in the mask 304, and is represented to be “1101.” While mask 304 is shown as a length 4 string, the mask length can be more than 4 or less than 4. In one example, the mask 304 could be length 3, i.e. “101,” And define a k-mer of length 2. In one embodiment, the mask 304 can be 33-bits, consisting of all 1's, with a single “0” in the mask. The single 0 in the mask 304 could be the second to last digit; however, the “0” could be positioned in other locations in the mask 304. The “0” could also be excluded and then the length of the mask 304 would equal the length of the k-mer that the mask 304 defines when applied to the biological sequence. The mask 304 can always define a length of a k-mer (e.g., number of “1's” in the mask less the number of “0's” in the mask. Accordingly, the length of the k-mer can never exceed the length of the mask 304.

The mask 304 can be initially positioned at the beginning of the reference genome, which can be referred to as offset position 0. When the mask 304 consisting of “1101” is applied to the first four nucleotides of reference genome 302 (AANG) the result is a position k-mer 306 of “AAG.” This is due to the fact that in this example, the “0” of the mask 304 corresponds to the “N” of the reference genome 302, and as a result of the applied definition of the “0”, the “0” can cancel out the corresponding nucleotide value. The masked element, or removed base as described above, need not be an “N,” but can be any one of the bases contained in the biological sequence. For example, the “1101” mask applied to the “GGCT” reference sequence can produce the k-mer GGT at position 1 in the reference sequence. Once the filter has been applied, the resulting position k-mer is stored in an index 308 with the corresponding filter offset position 310. The mask 304 can then be moved to the next offset position. In one embodiment, the mask 304 can be moved by 1 nucleotide position, (i.e. Offset Position 1 in FIG. 3). This allows for full sampling of the reference genome 302. Alternatively, the mask 304 could be moved by the length of the mask 304 and be applied to the next 4 nucleotide bases (i.e. Offset Position 4 in FIG. 3). This can allow for sub-sampling of the reference genome. Full sampling of the genome can provide the most accurate index of the reference genome, but will require more memory to store. Sub-sampling can reduce the storage requirements, but will be less accurate.

In one embodiment, once the mask 304 has been applied to every element of the reference genome 302, and all of the offset positions 310 and corresponding position k-mers 306 have been stored, the data can further be filtered to remove any position k-mers 306 that contain an improper element, (i.e. “N”).

Additionally, in some embodiment, using a mask to transform the reference genome into k-mers 306 can allow for errors in the k-mer. For example, it is currently understood that there are variations between genomes, even among the same species (e.g. human beings). By applying a gapped filter as discussed above, location k-mers 306 can be developed into an index that can account for variations between the reference genome and a set of read data. This can allow for subsequent searching of the index to be more robust, as it can allow for mismatches in a subsequent Candidate Alignment Location search (CAL). The location of the “0” in the mask 304, which removes the corresponding base in the sequence can allow for the mismatches as it can allow any sequence with any base at the “0” location continue to match the k-mer 306. For example, the mask “1101” applied to the sequence GGTC produces the k-mer GGC. Therefore, with an alphabet of A, C, G, T, the allowed reads that could match the reference sequence are GGAC, GGCC, GGGC, and GGTC, as the mask 304 applied to each of the above read data sequences can produce the same k-mer, GGC.

In a further embodiment, the position k-mers 306 can be converted to base-4 numbers. For example, base nucleotides (A, C, G, T) can be encoded into base-4 using the following equation with s being the sequence of letters and {φ(A)=0, φ(C)=1, φ(G)=2, φ(T)=3}:

$$ϕ ( s ) = {\sum }_{i = 0}^{\vert s \vert} {4}^{i} {s}_{i} \qquad Equation 1$$

Thus, for the k-mer “G T A,” the resulting base 4 value calculation can be seen in Equation 2.

$$ϕ ( GTA ) = {4}^{0} ϕ ( G ) + {4}^{1} ϕ ( T ) + {4}^{2} ϕ ( A ) \underline{= 1 * 2 + 4 * 3 + 16 * 0} \underline{= 14} \qquad Equation 2$$

By encoding the position k-mers into base-4, the number of bytes required for storage of the reference genome can be reduced to 25% of the number of bytes required using a standard base-10 numerical representation for each base nucleotide. Base-4 coding is an advantageous encoding format for biological data as, typically, each nucleotide base (i.e., A, C, G, T) are stored each in 1-byte (8 bits) data increments. Using base-4 encoding, each base can be expressed such that up to four bases can fit be stored using no more than a single byte. For example, each base can be assigned a base-4 value (A=00; C=01, G=10, T=11) illustrating that the 4 bases have a total of 8 bits or 1 byte. Base-4 encoding can further provide an advantage over ASCII type encoding as the base-4 allows for all operations can be confined to a 4-bit representation. This can produce faster operations in the index and on the HASH table disclosed above. Additionally, other types of encoding could also be used such as base-2, hexadecimal, etc.

In one embodiment, an index can be created using fast route index creation. It is understood that the there is ultimately very little variation between human genomes on an individual to individual level. A standard human genome contains approximately 3 billion base pairs, if which maybe 1%, or 3 million base pairs, have been found to potentially vary. Some of these variations can be associated with various personal traits, such as eye color, hair color, etc. However, some are associated with specific, and sometime adverse, mutations associated with genetic disorders. Non-limiting examples of genetic disorders can include cystic fibrosis, Huntington's disease, down syndrome, etc. These variations are known, and therefore only the portions of the reference genome relating to known variations can be indexed using a masking technique, such as that described above. This can allow for smaller index sizes, and can therefore potentially allow for faster analysis of read data, as will be discussed in more detail below.

After the reference genome has been indexed, the sequence alignment process 200 can create a library of indexes based on a reference genome at process block 206. Additionally, the library of indexes can be created based on multiple reference genomes, reference genomes combined with a database of known variant sites and different alleles. In one embodiment, where the data subsets (i.e. k-mers) were converted to base-4 numbers, the library can be searched in a manageable and search efficient manner. The library of indexes can be organized in an associative array, such as a HASH table. In one embodiment, the sequence alignment process 200 can generate a HASH table at process block 206 by defining HASH's of j-mers. The j-mers can be sized such that they are less than or equal to the length of the k-mers. In one embodiment, the j-mers can have a length less than that of the k-mers such that the HASH table can allow for searching of position k-mers based on a portion of the actual k-mer value.

For example, a given subset of data in the index can contain the following k-mers GGTCA, GGAAC, GGTTG, GGGG. The preceding k-mers can be located at positions 100-103 in the index using Equation 1. The HASH table could subsequently contain j-mers of length 2, with the j-mer GG pointing to position 100 in the index. Thus, rather than scanning the entire index for the k-mer, the j-mer searching can allow the sequence alignment process 200 to look into only a subset of the index that will possible contain the k-mer. The j-mer size in relation to the k-mer size can have an impact on the speed of a search for a given read data. For example, where the length of the j-mer is equal to the length of the k-mer, then the lookup time could be expressed as 0(1) because the HASH table would determine exactly where each k-mer is located within the index in that instance. Where the length of the j-mer is less than the length of the k-mer, the lookup time will be slower than where the length of the j-mer is equal to the length of the k-mer. Finally, where the j-mer has a length of 1, the search would only be slightly more advantageous than not using a HASH table as only k-mers starting with A, C, G, and/or T would be able to be evaluated.

Furthermore, once the reference genome has been indexed, it will generally no longer be required to be indexed again. The indexed reference genome can be used in an alignment process once it indexed with new incoming input data without having to be re-indexed. This can be attributed to the library of indexes, which can contain indexed reference genomes of different population segments. The population segment indexes can be accessed when performing an alignment of a similar population segment. For example, a Latin American reference genome can be selected from the library of indexes when aligning input data of a Latin American individual. In one embodiment, the populations can be broad (Latin American, North American, Asian, etc.) Alternatively, the population segments can have a finer granularity (e.g. Mexican, Icelandic, Korean, etc.).

Once the library of indexes has been created at process block 204, the alignment process 200 can obtain read data at process block 208. Read data can be provided via a sequencing instrument 106. Once the read has been received the sequence alignment process 200 can perform an alignment on the data at process block 210. The data alignment process 210 can encode the read data and subsequently compare the encoded read data against the encoded reference genome. In one embodiment, the data alignment process 210 can be performed using a single machine. Alternatively, multiple machines working in conjunction can be used to align the data. Furthermore, the data alignment process 210 can use a pre-sorting alignment method. Further still, the data alignment process 210 can use a post-sorting alignment method. Exemplary data alignment processes are described in more detail below.

In one embodiment, a data processing system, such as data processing system 100 discussed above, can be configured to concurrently process two or more sets of biological sequences (e.g. genomes) at a time. The system can read the sequence data of the biological entities and process the alignment tasks in parallel, allowing for the genomes to be completed at substantially the same time. Utilizing a parallelization algorithm in conjunction with parallelizable hardware architecture can significantly reduce processing time. In some embodiments, the number of genomes to be processed in parallel is at least 1. Alternatively, more than one genomes can be processed in parallel. In one embodiment, the parallelization algorithm can focus on the optimization of the use of parallel arrays of units of embedded systems and memory (e.g., RAM) allocation. This optimization of using parallel arrays can result in the optimization of the alignment of hundreds to thousands of genomes at a time. Further, the parallelization algorithm can distribute the input data across multiple computing devices, each of which can store a local copy of the reference, index, hash, and other optional database information. Further, multiple computing devices, as described above, can perform calculations on the aligned data without requiring load balance of the data overhead. Thus, the parallelization algorithm can result in linear scalability of the parallel processing.

The distribution of data between computing devices by the parallelization algorithm can be accomplished using a secure UDP protocol. Alternatively, the distribution can be accomplished using intranet lines, internet lines, Universal Serial Bus (USB), firewire, fiber optic, high-speed earth to satellite to earth communication, Wi-Fi, Bluetooth, cellular (CDMA, GSA, 3G, 4G, LTE), radio frequency and any other type of communication technology between computing devices.

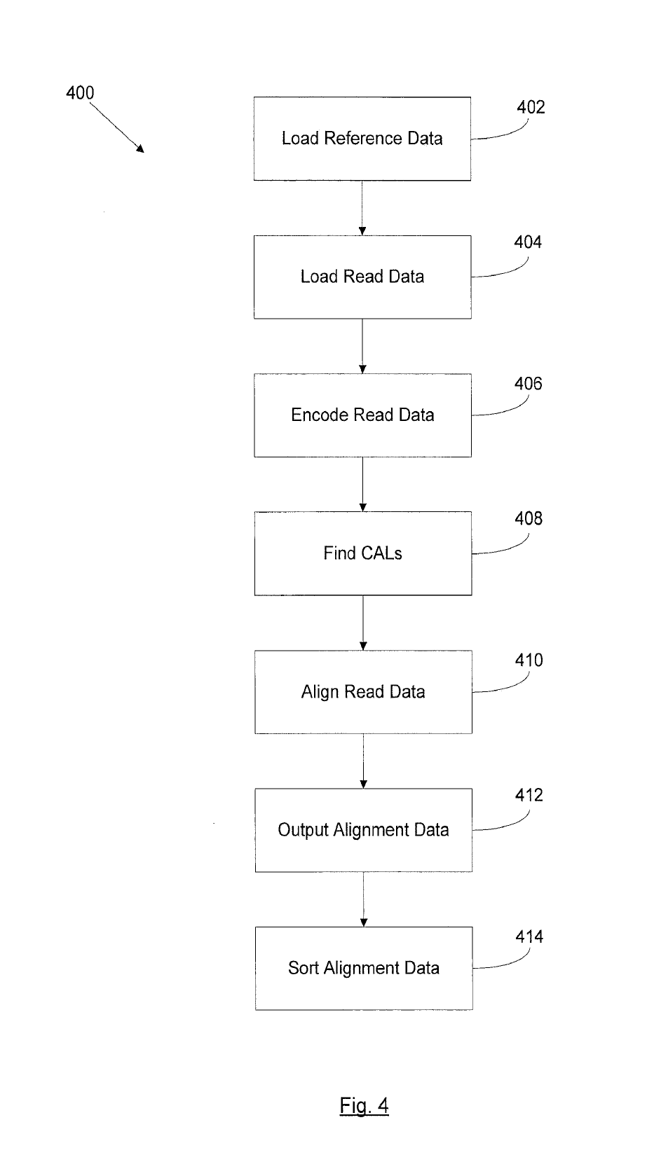

Turning now to FIG. 4, an example of a single machine alignment with post-sorting (“post-sort”) process 400 can be seen. In one embodiment, the single machine can be a computing device as disclosed above. At process block 402 the post-sort process 400 can load reference data. In one embodiment, the reference data can include an index of a reference genome, and a HASH array of the index of the reference genome. At process block 404, the read data along with associated quality scores can be loaded into the machine.

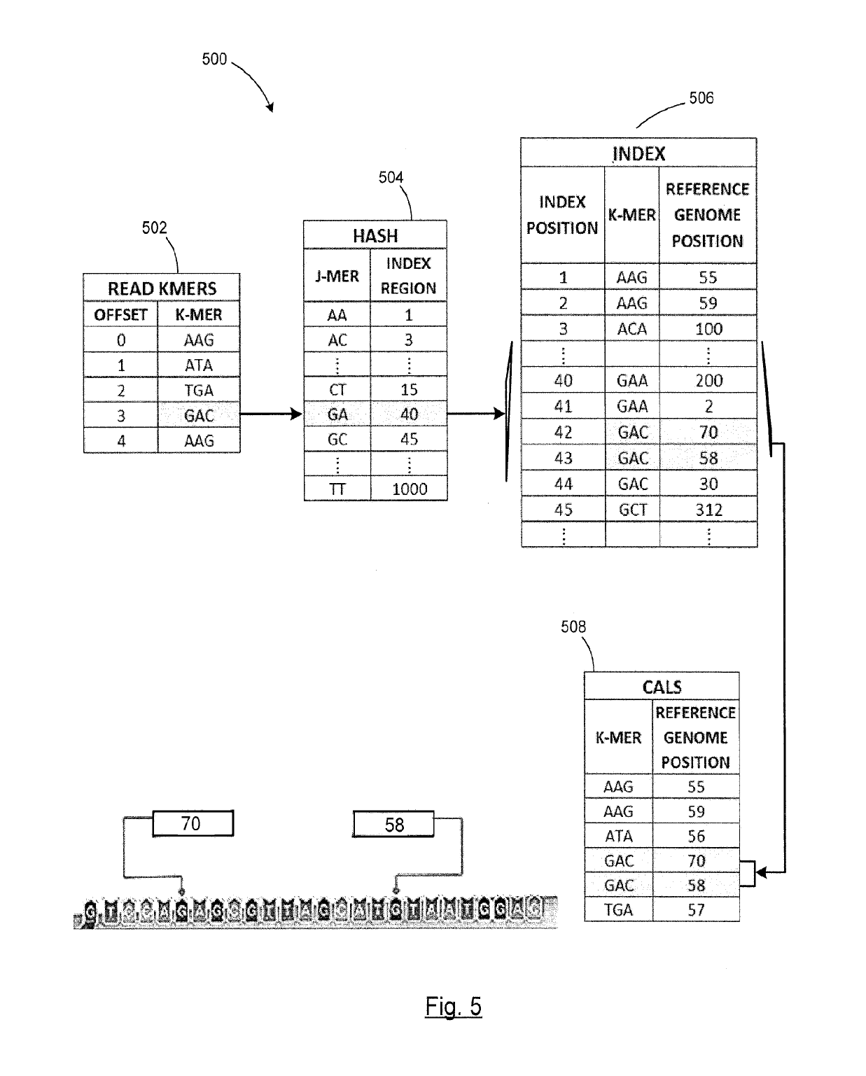

At process block 406 the read data can be encoded. In one embodiment, the read data can be encoded by applying a mask to the read data. For example, the same mask used to encode the reference genome can be applied to the read data. The application of a mask to the read data can produce a set of encoded k-mers that correspond to the data in the loaded read data. The encoding process as described in FIG. 3, and above, can be applied to the read data. Accordingly, the encoded read data can include offset positions and associated k-mers as described above. Once the read data has been encoded at process block 406, the encoded read data k-mers can be compared to the reference index to find a series of Candidate Alignment Locations (“CALs”)_in the reference genome at process block 408. This process is described in detail in FIG. 5.

Turning now to FIG. 5, an example read data comparison process 500 can be seen. At process block 502 a read k-mer can be selected to be compared to the reference data. As shown in this example, the read k-mer at offset position “3” is selected, which is represented by the k-mer GAC. The selected k-mer GAC can then be compared against corresponding j-mers in the HASH table 504. For example, the selected k-mer GAC, corresponds to the j-mer GA, as shown. The reference j-mer GA is shown in the example HASH table 504 to correspond to the index positions 40-44 in the index 506. Once the index positions containing the referenced j-mer have been determined, the referenced index positions can then be searched to determine which, if any, of the index positions contain the selected k-mer. In this example, index positions “42” and “43” contain the k-mer GAC, which corresponds to reference genome positions “70” and “58.” The reference genome positions being known, the read data comparison process 500 can then look up CALs associated with the reference genome positions in CAL index 508. In some embodiments, the k-mers can be looked up in the directory of indexes as described above. For example, each k-mer can be looked up in a HASH table to find regions in the index where the k-mers can be located. Subsequently, a binary search for specific k-mers can be performed to locate the CALs.

Additionally, where the k-mer size is less than the read data length, the masked lookup of read data in the index 506 can only match locations in the reference data equal to the k-mer length. Thus, the remaining length of the read data has yet to be aligned to the reference data. The location in the reference data of the non-aligned portion of the read data can be the CAL. Each read can have multiple CALs. An alignment algorithm, such as the Smith-Waterman algorithm, when applied to the non aligned portion of read data and reference data can provide the TRUE alignment locations, subject to the effect of the mask and the alignment algorithm in introducing mismatched data. For example, if the reference data is ACCCCCCCAATGT and the input read data is CCCCAATG, and the mask is “1111,” a k-mer of the input read can be “CCCC.” This k-mer can align to the reference data at positions 2, 3, 4, and 5 (all possible locations of CCCC in the reference data.). These three positions would therefore be CALs as they are possible locations for the masked read data. In this example, the input read data would finally align to the reference data at position 5, where there is a perfect match. This methodology can allow for mismatches, insertions, and/or deletions. For example, if the above k-mer is aligned at position 4 with 1 insertion, the CAL could be represented as CCCC-AATGT, where the “-” represents an insertions with respect to the reference data.

Returning now to FIG. 4, each CAL determined in process block 408 can be used to align the read k-mer to the reference genome using an alignment algorithm at process bock 410. In one embodiment, the algorithm can be a Smith-Waterman algorithm. The Smith & Waterman algorithm can have a complexity of 0 (nm). Alternatively, other algorithms can be used, such as FAST_LCS algorithms can be used. FAST_LCS algorithms can have a complexity of 0 (|longest common substring|). The alignment algorithms can output alignment data which correlates the read k-mers to the reference genome. In one embodiment, the alignment algorithm can output data indicating the length of the match of the read data to the reference genome. For example, if the read is length 101 and matches the reference at the CAL completely, the output data can be 101M for 101 matching data points. If the read contains an extra or different letter at a position in the reference genome, e.g. position 58, and the rest of the read matches the reference genome, the output data for that read can be 57M1I43M (57 matches, 1 insertion, 43 matches). The above numbers with the associated letter indications (M, I, D, etc) can be referred to as CIGAR scores.

Once each read k-mer has been aligned, the alignment data can be output to an output file at process block 412. In one embodiment, the output file can be stored locally in a memory. Alternatively, the output file can be transmitted to a remote storage devices, such as a secure server. When transmitting the output file to a remote storage device, quality of service (QoS) and evaluations of routing paths with the highest available bandwidth should be considered. The transmission of the output file can be a transmission of the entire output file. Alternatively, where there is limited bandwidth and/or limitations associated with the secure server, only portions of the output file may be transmitted. For example, the offset information and the CIGAR scores.

Once the alignment data has been placed in the output file, the alignment data can be sorted such that the alignment data can be sorted to be placed in the same order as the reference genome at process block 414. The positions of the read data having been determined by the alignment algorithm, the alignment data can be sorted by this position, such that the read data that aligned to positions at the beginning of the reference genome are placed before the read data that aligned in the middle of the reference genome, which are further sorted before read data that aligned to the end of the reference genome. Sorting the alignment data based on the order of the reference genome can structure the read data to correspond to the reference genome.

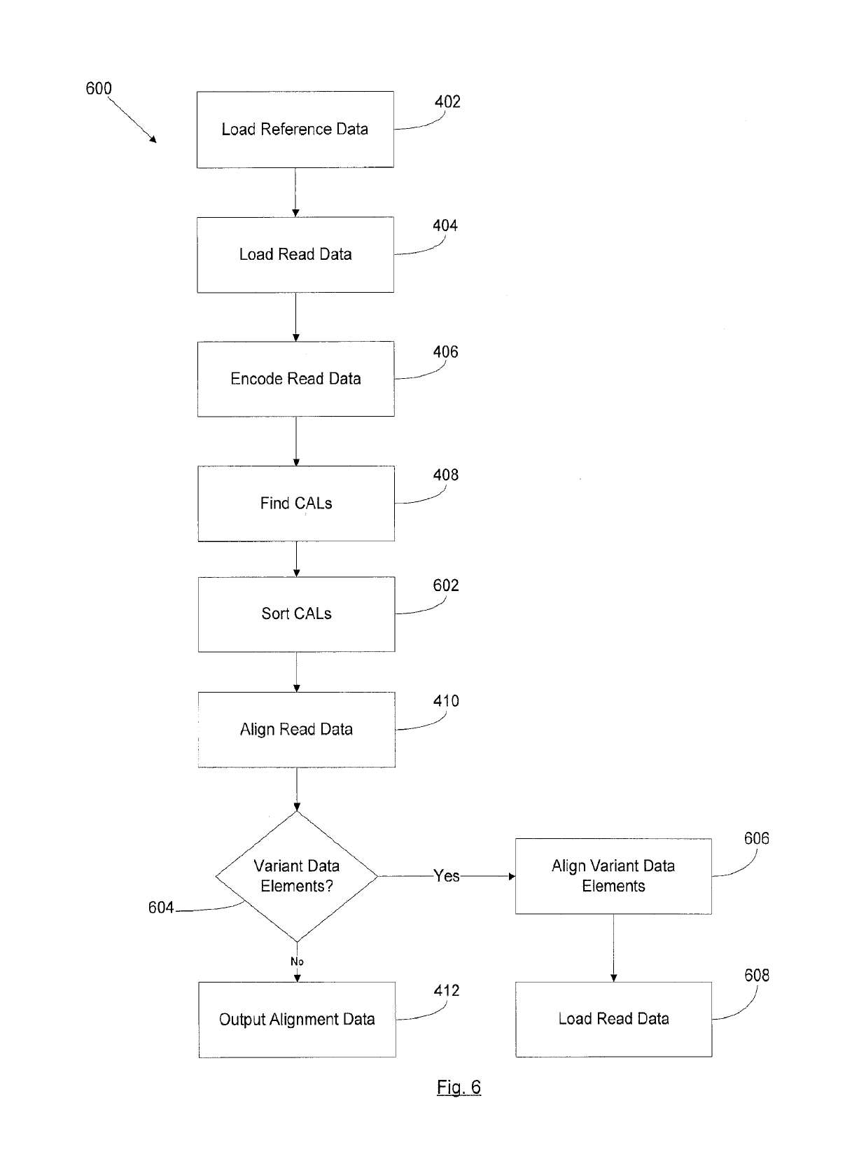

Turning now to FIG. 6, an example of a single machine alignment with pre-sorting (“pre-sort”) process 600 can be seen. The pre-sort process 600 generally includes similar processes to those discussed in relation to the post-sort process 400 in FIG. 4. Accordingly, the below description of FIG. 6 discusses only those processes which generally differ from those discussed above relating to FIG. 4.

At process block 602, the pre-sort process 600 can sort the CALs found at process block 408. In one embodiment, the CALs associated with the read data can be sorted based on the location of the CAL with respect to the associated position in the reference genome. For example, the CALs can be sorted such that they are placed in order of their positions within the reference genome.

Once the CALs have been sorted, they can then be aligned at process block 410. Further, once the CALs have been aligned, the pre-sort process 600 can determine if there are variant data elements at process block 604. Variant data elements can be portions of the read data having mismatches, insertions or deletions compared to the reference sequence. Variant data elements can be the result of poor or incorrect reads, mutated biological data, etc. Accordingly, in some instances, variant data elements can be crucial to evaluating sequencing data, as it can quickly show discrepancies between the reference genome and the read data. If variant data elements are not present at process block 604, the pre-sort process 600 can output the alignment data to an output file at process block 412.

Where the pre-sort process 600 does determine that there are variant data elements at process block 604, the pre-sort process 600 can align the variant data elements at process block 606. In one embodiment, the variant data elements can be determined using a variant calling algorithm, or an algorithm that can identify areas of the aligned read data that are potentially different from the reference genome or have an appreciable amount of noise and/or error as determined based on base quality scores. Once the variant calling algorithm is completed, the pre-sort process 600 can report the variant data elements to a variant data element output file at process block 608. In one embodiment the variant data output file can be stored locally in a memory. Alternatively, the variant data output file can be transmitted to a remote storage device, such as a secure server. Further, the variant data output file can be in a variant data format, such as that discussed above.

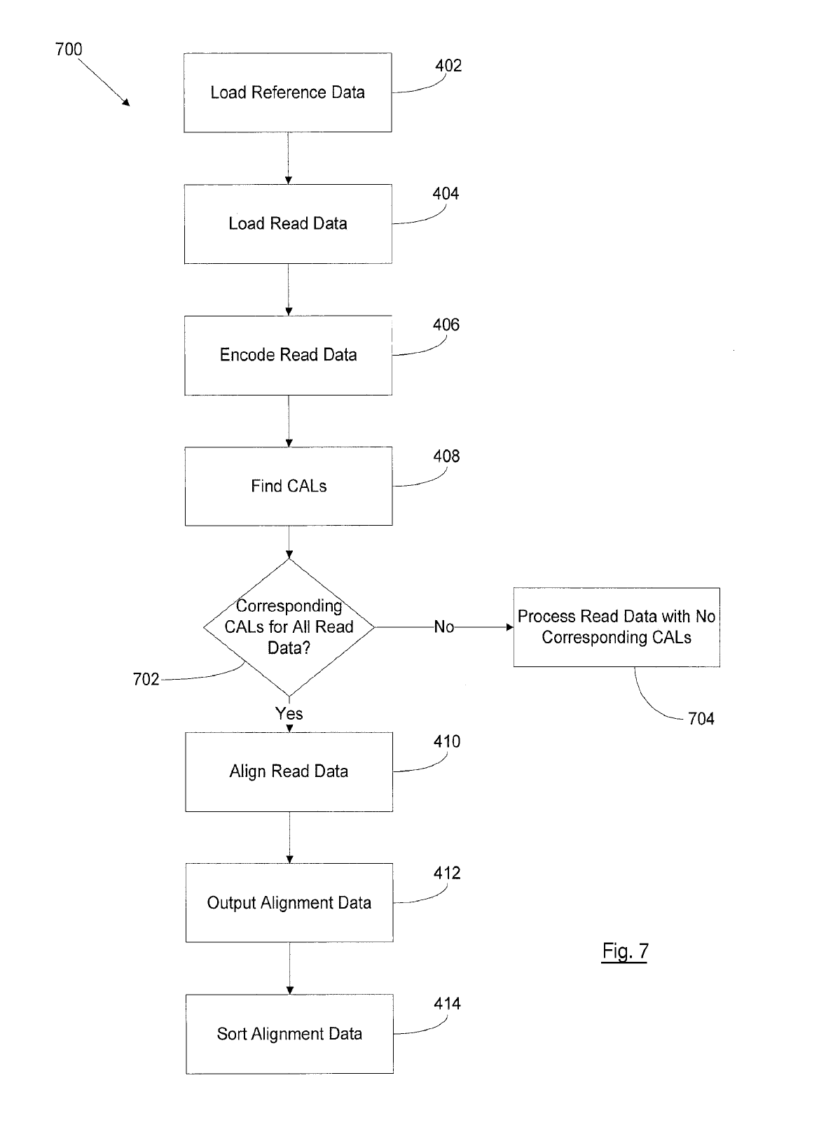

Turning now to FIG. 7, an example of a fast route single machine alignment with post-sorting (“fast post-sort”) process 700 can be seen. The fast post-sort process 700 generally includes similar processes to those discussed in relation to the pre-sort process 400 in FIG. 4. Accordingly, the below description of FIG. 7 discusses only those processes which generally differ from those discussed above relating to FIG. 4.

In the fast post-sort process 700, the reference genome, fast route index, and HASH array of the fast route index can be loaded at process block 402. In one embodiment, the fast route index can be created as discussed above. Once the fast post-sort process 700 finds a series of CALs at process block 408, the fast post-sort process 700 can then determine if there are portions of the read data that do not have corresponding CALs at process block 702. If there are no CALs for portions of the read data, that read data can be processed at process block 704. In one embodiment, the portions of the read data with no CALs can be transmitted to a compression engine. The compression engine can apply standard compression techniques to reduce the file size of the read data. Alternatively, the portions of the read data with no CALs can be placed into an electronic file and stored on a memory, such as an external hard disk.

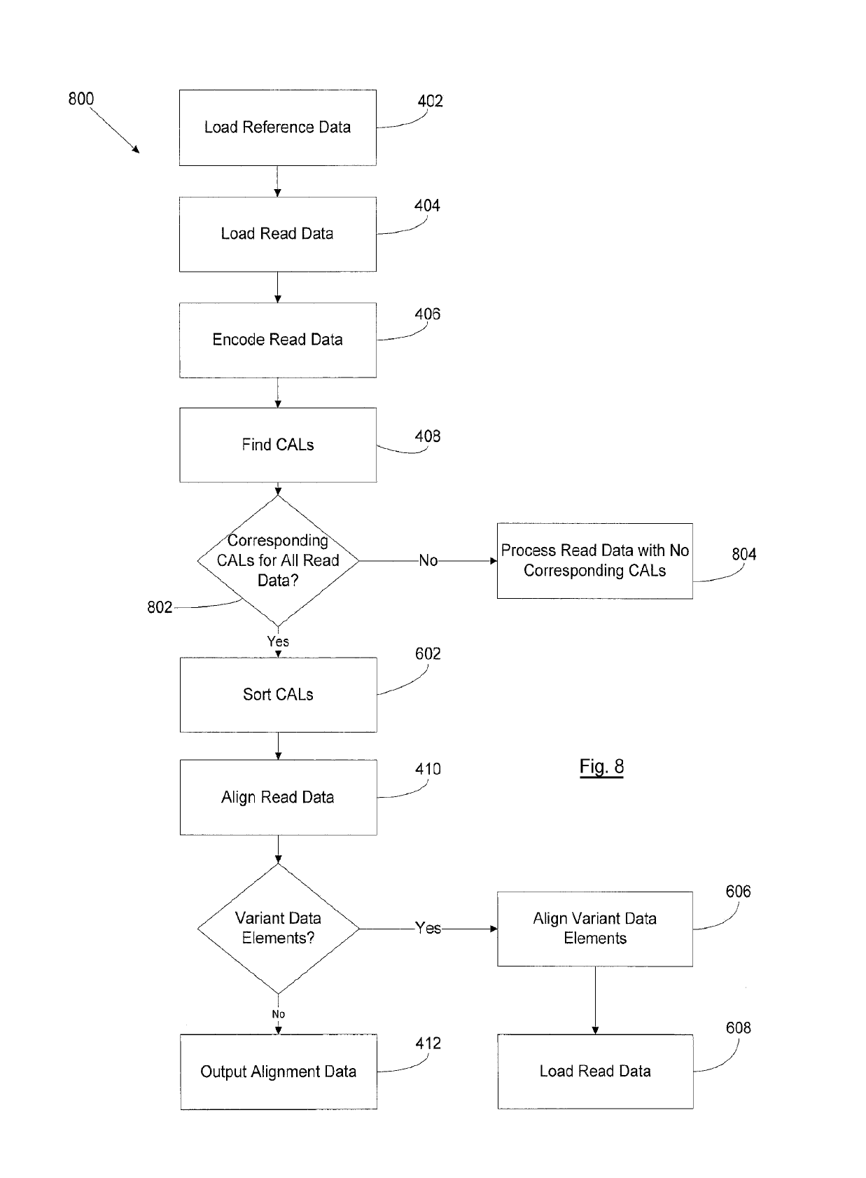

FIG. 8 provides an example of a fast route single machine alignment with pre-sorting (“fast pre-sort”) process 800 The fast pre-sort process 800 generally includes similar processes to those discussed in relation to the pre-sort process 600 in FIG. 6. Accordingly, the below description of FIG. 8 discusses only those portions of the process which generally differ from those discussed above relating to FIG. 6.

In the fast pre-sort process 800, the reference genome, fast route index, and HASH array of the fast route index can be loaded at process block 402. In one embodiment, the fast route index can be created as discussed above. Once the fast pre-sort process 800 finds a series of CALs at process block 408, the fast pre-sort process 800 can then determine if there are any portions of the read data that do not have corresponding CALs at process block 802. If there are not CALs for portions of the read data, that read data can be processed at process block 804. In one embodiment, the portions of the read data with no CALs can be transmitted to a compression engine. The compression engine can apply standard compression techniques to reduce the file size of the read data. Alternatively, the portions of the read data with no CALs can be placed into an electronic file and stored on a memory, such as an external hard disk.

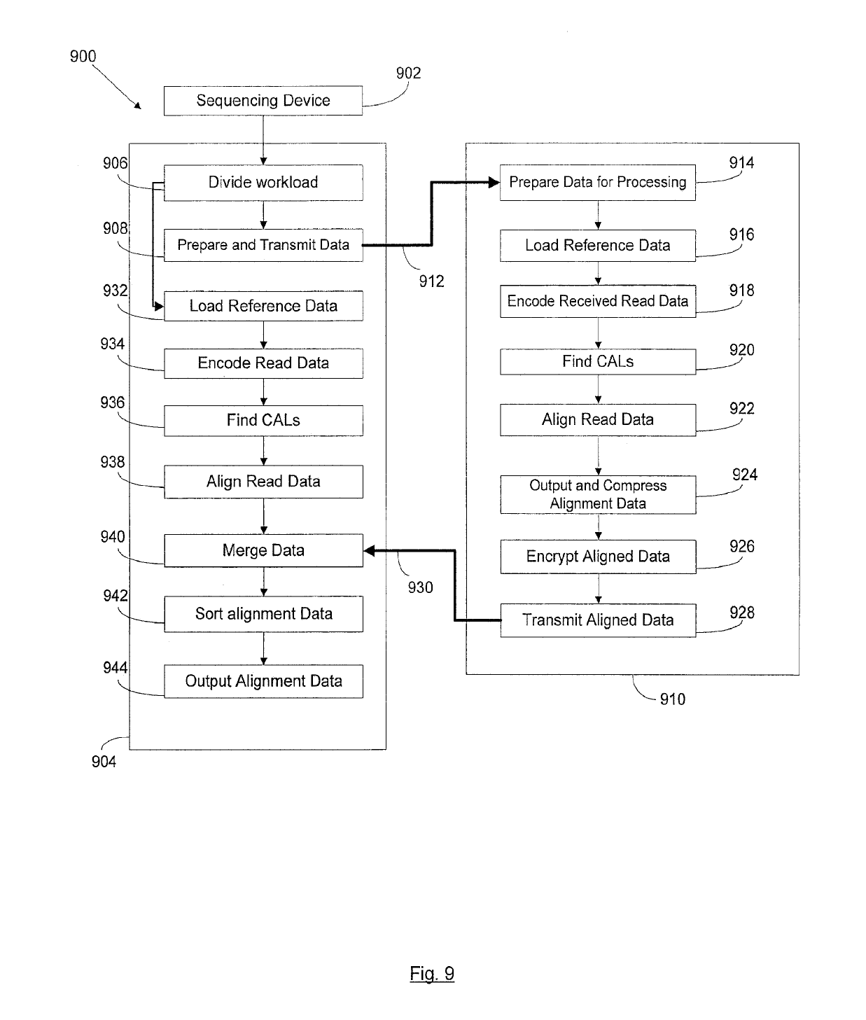

Turning now to FIG. 9, a remote genome alignment with post-sorting (“remote post-sorting”) process 900 can be seen. Read data can be generated via sequencer device 902. Non-limiting examples of types of sequencing devices 902 can include single-molecule real-time sequencing, ion semiconductor, pyrosequencing, sequencing by synthesis, sequencing by ligation, and chain termination. Alternatively, sequencing device 902 can be a computing device capable of receiving previously captured biological sequence data. Sequencing device 902 can transmit biological sequence data to a first client 904.

The first client 904 can be a computing device as described above. The first client 904 can analyze the data received from the sequencing device 902 and determine how to divide the workload at block 906. In one embodiment, the first client 904 can determine how to divide the workload based on the amount and/or type of data received. Furthermore, the first client 904 can determine how to divide the workload based on the other available computing devices available to process the data. For example, the first client 904 may evaluate other available computing devices free processing capabilities, available memory, connection speeds, physical location, time availability, etc., as non-limiting examples, when determining how to divide the workload. Additionally, the first client 904 can use statistics relating to the performance of the multiple analysis device to which it has access. These statistics can be known by the first client 904 or the first client 904 can collect the statistical data from the multiple analysis devices at the time it determines how to divide the workload. Non-limiting examples of statics used by the first client 904 can include individual thread speed, average processing times, etc. In one example, the first client 904 can collect these values over time which can allow for accurate distribution of work where the performance of a particular analysis device does not perform as specified.

Once the first client 904 has determined how the workload is to be divided, it can then prepare and transmit the data at block 908. In one embodiment, the first client 904 can prepare the data by encrypting the data using a known encryption method. In one embodiment, the encryption can be a one-time cipher encryption. For example, a one-time cipher using modulo addition could be used. Additionally, the first client 904 can also prepare the data by compressing it prior to transmission. In one embodiment, the data can be compressed using a compression by alignment methodology or a compression by reference methodology. Alternatively, other types of compression could also be used. Once the data has been prepared, it can then be transmitted to one or more additional devices, such as the second client 910, using communication link 912. While FIG. 9 shows only two client devices, it should be understood that more than two client devices could also be used. The second client 910 can be can be a computing device as described above. In one embodiment, the second client 910 can be the same type of computing device as the first client 904. Alternatively, the second client 910 can be a different computing device from the first client 904. In one embodiment, the communication link 912 can be an intranet type network. Alternatively, the communication link 912 can be an internet type network, universal serial bus, firewire, fiber optic, high-speed earth to satellite to earth communication, Wi-Fi, Bluetooth, cellular (CDMA, GSA, 3G, 4G, LTE), radio frequency or any other type of communication technology capable of transmitting and receiving the sequencing data.

Once the data has been received by the second client 910, it can be prepared for processing at process block 914. In one embodiment, the second client 910 can prepare the data for processing by decompressing the data. Additionally, the second client 910 can prepare the data for processing by decrypting the received data. Once the data has been prepared, the second client 910 can load reference data at block 916. In one embodiment the reference data can include an index of a reference genome, and a HASH array of the index of the reference genome.

At block 918 the read data can be encoded. In one embodiment, the read data can be encoded by applying a mask to the read data. For example, the same mask used to encode the reference genome can be applied to the read data. The application of a mask to the read data can produce a set of encoded k-mers that correspond to the data in the loaded read data. The encoding process as described in FIG. 3, and above, can be applied to the read data. Accordingly, the encoded read data can include offset positions and associated k-mers as described above. Once the read data has been encoded at process block 918, the encoded read data k-mers can be compared to the reference index to find a series of Candidate Alignment Locations (“CALs”) in the reference genome at process block 920.

Once each CAL has been determined in process block 920, the CALs can be used to align the read data to the reference genome using an alignment algorithm at process block 922. In one embodiment, the algorithm can be a Smith-Waterman algorithm. The Smith & Waterman algorithm can have a complexity of 0 (nm). Alternatively, other algorithms can be used, such as FAST_LCS algorithms can be used. FAST_LCS algorithms can have a complexity of 0 (|longest common substring|). The alignment algorithms can output alignment data which correlates the read k-mers to the reference genome.

Once each read has been aligned, the alignment data can be output to an output file and compressed at process block 924. Additionally, CIGAR scores and offsets determined during the alignment can also be output and compressed at block 924. The compressed alignment data can then be encrypted at process block 926 and transmitted at block 928 to the first client 904 over communication link 930. Communication link 930 can be the same communication link as communication link 912. Alternatively, communication link 930 can be a separate type of communication link.

The first client 904, after dividing the workload at process block 906 can decide to process some of the data internally. The first client 906, determining what data it will process can load reference data at block 932. In one embodiment, the reference data can include an index of a reference genome, and a HASH array of the index of the reference genome.

At block 934 the read data can be encoded. In one embodiment, the read data can be encoded by applying a mask to the read data. For example, the same mask used to encode the reference genome can be applied to the read data. The application of a mask to the read data can produce a set of encoded k-mers that correspond to the data in the loaded read data. The encoding process as described in FIG. 3, and above, can be applied to the read data. Accordingly, the encoded read data can include offset positions and associated k-mers as described above. Once the read data has been encoded at process block 934, the encoded read data k-mers can be compared to the reference index to find a series of Candidate Alignment Locations (“CALs”) in the reference genome at process block 936.

Once each CAL has been determined in process block 936, the CALs can be used to align the read data to the reference genome using an alignment algorithm at process block 938. In one embodiment, the algorithm can be a Smith-Waterman algorithm. The Smith & Waterman algorithm can have a complexity of 0 (nm). Alternatively, other algorithms can be used, such as FAST_LCS algorithms can be used. FAST_LCS algorithms can have a complexity of 0 (|longest common substring|). The alignment algorithms can output alignment data which correlates the read k-mers to the reference genome.

Once each full read has been aligned, the alignment data can be combined with the data received from the second client 910 at process block 940 in a sorted order corresponding to the locations of the alignment data with respect to the reference genome.

After the data from the first client 904 and the second client 906 have been merged, the first client 904 can sort the aligned data such that the aligned data can be sorted to be placed in the same order as the reference genome at process block 942. Sorting the alignment data based on the order of the reference genome can structure the read data to correspond to the reference genome. The aligned data having been sorted at block 942, the first client can output the alignment data to an output file at process block 944.

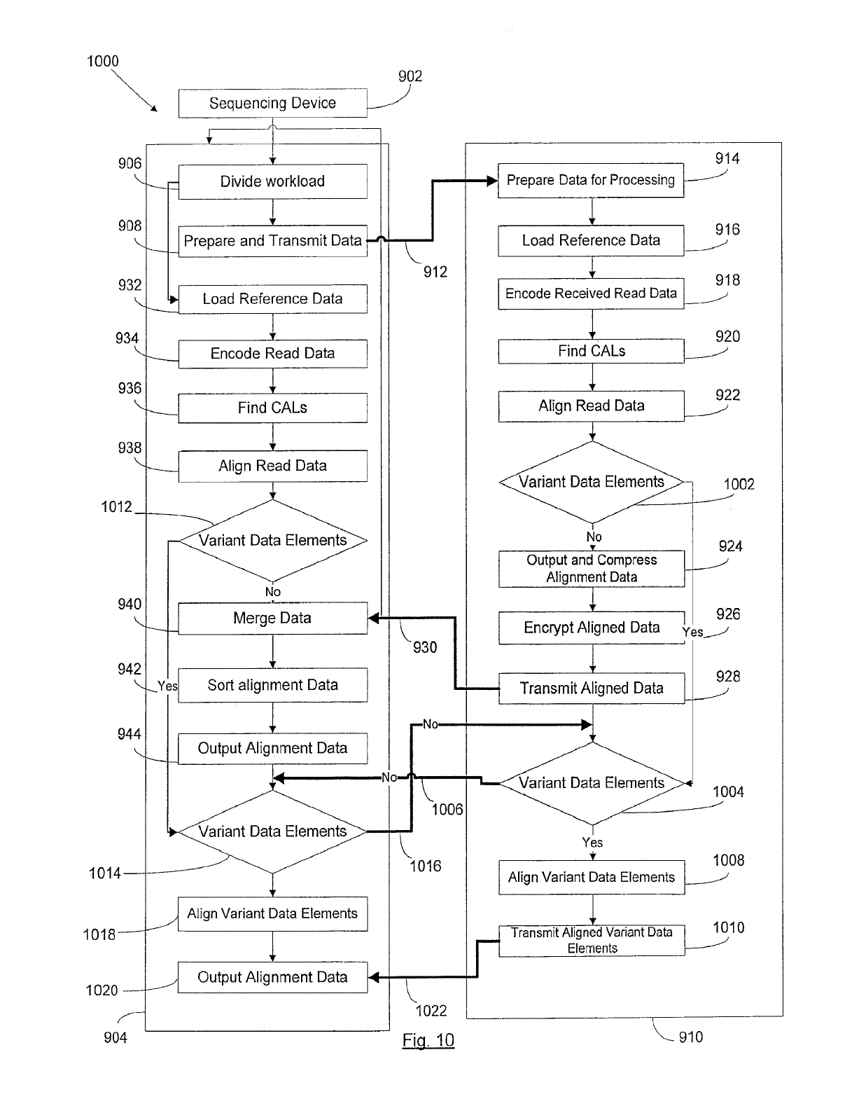

FIG. 10 provides an example of a remote genome alignment with pre-sorting (“remote post-sorting”) process 1000. The remote pre-sort process 1000 generally includes similar processes to those discussed in relation to the remote pre-sort process 900 in FIG. 9. Accordingly, the below description of FIG. 10 discusses only those portions of the process which generally differ from those discussed above relating to FIG. 9

The first client 904 can analyze the data received from the sequencing device 902 and determine how to divide the workload at block 906. Once the first client 904 has determined how the workload is to be divided, it can then prepare and transmit the data at block 908 where it is received by the second client 910. The second client 910 can prepare the received data for processing at process block 914. The second client 910 can load reference data at block 916, encode the received data at process block 918, find a series of CALs at process block 920, and align the read data at process block 922. Once the read data has been aligned at process block 922, the second client 910 can determine if there are variant data elements at process block 1002 in the second client 910. Variant data elements can be portions of the read data that have mismatches, insertions or deletions compared to the reference sequence. Variant data elements can be the result of poor or incorrect reads, mutated biological data, etc. Accordingly, in some instances, variant data elements can be crucial to evaluating sequencing data, as it can quickly show discrepancies between the reference genome and the read data. If variant data elements are not present at process block 1002, the remote pre-sort process 1000 can output the alignment data to an output file and compress the data at block 924. The compressed alignment data can be encrypted at process block 926 and transmitted at block 928 to the first client 904 over communication link 930.

Where the second client 910 determines that there are variant data elements at process block 1002, the remote pre-sort process 1000 can then determine if the second client 910 contains a variant data offset relative to the aligned data and/or variant data elements at block 1004. Variant data offsets are the known locations in the reference genome where biological diversity is known to occur. Each client can contain specific regions of the reference genome relating to these locations of known biological diversity. If the second client 910 does not contain the variant data offsets relating to the aligned data and/or variant data elements determined by the second client 910, the second client 910 can communicate to the first client 904 at block 1004 that the second client 910 does not contain the variant data offsets, via communication link 1006. Thus, the first client 904 can know to process the data received from the second client 910 using the variant offset data of the first client 904. The individual clients can store the variable offset data in a memory. Further, while the present example shows two client devices, a remote genome aligner with pre-sorting can have more than two client devices.

Where the remote pre-sort process 1000 determines that there are variant data offsets in the second client 910 at process block 1004 that correspond to the alignment data and/or variant offset data, the remote pre-sort process 1000 can determine the variant data elements at process block 1008. In one embodiment, the variant data elements can be determined using a variant calling algorithm, or an algorithm that can identify areas of the aligned read data that are potentially different from the reference genome or have an appreciable amount of noise and/or error as determined based on base quality scores. Once the variant calling algorithm is completed, the second client 910 can transmit the determined variant data elements at block 1010 to first client 904.

The first client 904, after dividing the workload at process block 906 can decide to process some of the data internally. The first client 906, determining what data it will process can load reference data at block 932. In one embodiment, the reference data can include an index of a reference genome, and a HASH array of the index of the reference genome. The read data can be encoded at process block 934 and the encoded read data can be compared to the reference index to find a series of CALs at block 936. Once each CAL has been determined at block 936, the CALs can be used to align the read data to the reference genome using an alignment algorithm at process block 938. Once the read data has been aligned at process block 938, the first client 904 can determine if there are variant data elements at block 1012 in the first client 904. Variant data elements can be portions of the read data that have mismatches, insertions or deletions compared to the reference sequence. Variant data elements can be the result of poor or incorrect reads, mutated biological data, etc. Accordingly, in some instances, variant data elements can be crucial to evaluating sequencing data, as it can quickly show discrepancies between the reference genome and the read data. If variant data elements are not present at process block 1012, the remote pre-sort process 1000 can output the alignment data can be combined with the data received from the second client 910 at process block 940 in a sorted order corresponding to the locations of the alignment data with respect to the reference genome.

After the aligned data from the first client 904 and the second client 906 have been merged, the first client 904 can sort the aligned data such that the aligned data can be sorted to be placed in the same order as the reference genome at process block 942. Sorting the alignment data based on the order of the reference genome can structure the read data to correspond to the reference genome. The aligned data having been sorted at block 942, the first client can output the alignment data to an output file at 944.

Where the first client 904 determines that there are variant data elements at process block 1012, the remote pre-sort process 1000 can then the determine if the first client 904 contains a variant data offset relative to the aligned data and/or variant data elements at block 1014. Variant data offsets are the known locations in the reference genome where biological diversity is known to occur. Each client can contain specific regions of the reference genome relating to these locations of known biological diversity. If the first client 904 does not contain the variant data offsets relating to the aligned data and/or variant data elements determined by the first client 904, the first client 904 can communicate to the second client 910 at block 1014 that the first client 904 does not contain the variant data offsets, via communication link 1016. Furthermore, the first client can also transmit the variant data elements and/or aligned data associated with the variant offsets in the second client 910 over communication link 1016 for processing.

Where the remote pre-sort process 1000 determines that there are variant data offsets in the first client 904 at process block 1014 that correspond to the alignment data and/or variant offset data, the remote pre-sort process 1000 can determine the variant data elements at process block 1018. In one embodiment, the variant data elements can be determined using a variant calling algorithm, or an algorithm that can identify areas of the aligned read data that are potentially different from the reference genome or have an appreciable amount of noise and/or error as determined based on base quality scores. Once the variant calling algorithm is completed, the first client 904 can receive the variant data elements from the second client 910 at block 1020 via communication link 1022.

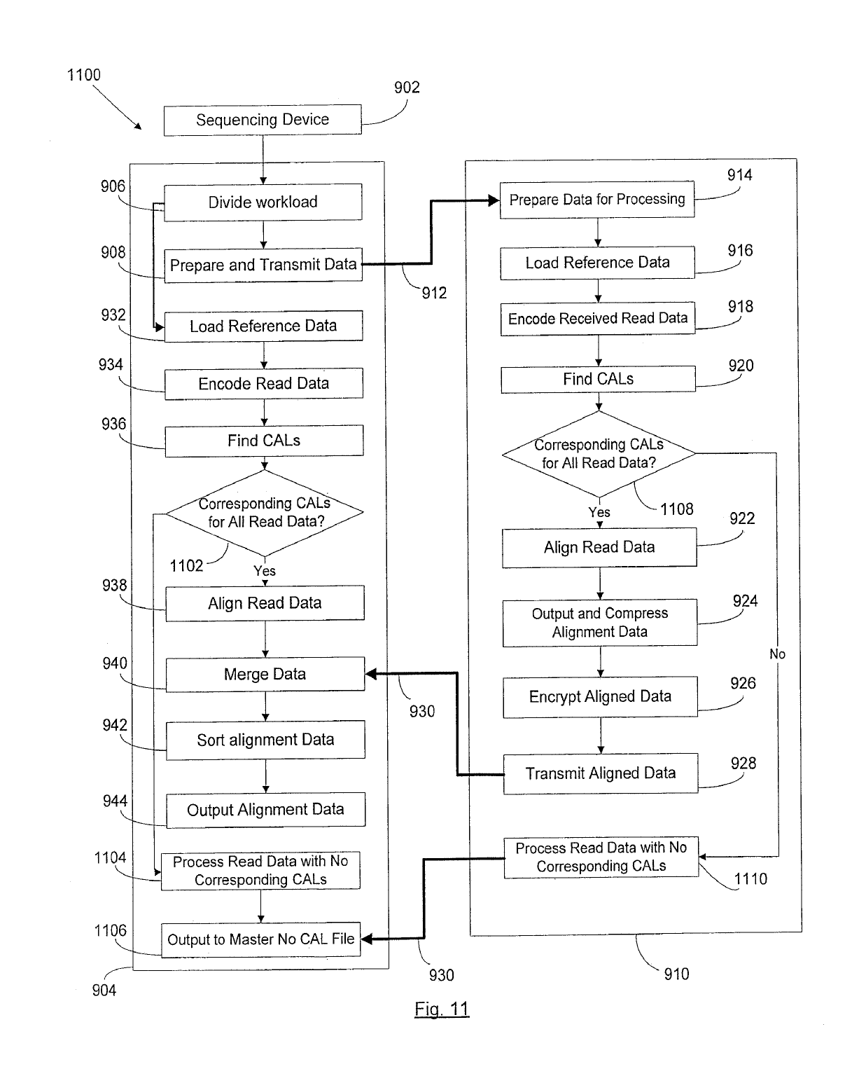

FIG. 11 provides an example of a fast route remote genome alignment with post-sorting (“fast remote post-sort”) process 1100. The fast pre-sort process 1100 generally includes similar processes to those discussed in relation to those discussed in relation to the remote pre-sort process 900 in FIG. 9. Accordingly, the below description of FIG. 11 discusses only those processes which generally differ from those discussed above relating to FIG. 9.

In the fast remote post-sort process 1100, the first client 904 can load the reference genome, fast route index, and HASH array of the fast route index at block 932. In one embodiment, the fast route index can be created as discussed above. Once the first client 904 finds a series of CALs at process block 936, the first client 904 can then determine if there are portions of the read data that do not have corresponding CALs at block 1102. If there are no CALs for portions of the read data, that read data can be processed at block 1104. In one embodiment, the portions of the read data with no CALs can be transmitted to a compression engine. The compression engine can apply standard compression techniques to reduce the file size of the read data. Alternatively, the portions of the read data with no CALs can be placed into an electronic file and stored on a memory, such as an external hard disk. The compressed data can then be output to the master no CALs file at block 1106. In one embodiment, the master no CALs file can be located in the first client 1106. Alternatively, the master no CALs file can be located in the second client 910, or another client, as applicable.

The second client 910 can load the reference genome, fast route index, and HASH array of the fast route index at block 916. In one embodiment, the fast route index can be created as discussed above. Once the second client 910 finds a series of CALs at process block 920, the second client 910 can then determine if there are portions of the read data that do not have corresponding CALs at block 1108. If there are no CALs for portions of the read data, that read data can be processed at block 1110. In one embodiment, the portions of the read data with no CALs can be transmitted to a compression engine. The compression engine can apply standard compression techniques to reduce the file size of the read data. Alternatively, the portions of the read data with no CALs can be placed into an electronic file and stored on a memory, such as an external hard disk. The compressed data can then be transmitted to the first client 910 via communication link 1112 and added to the master no CALs file at block 1106.

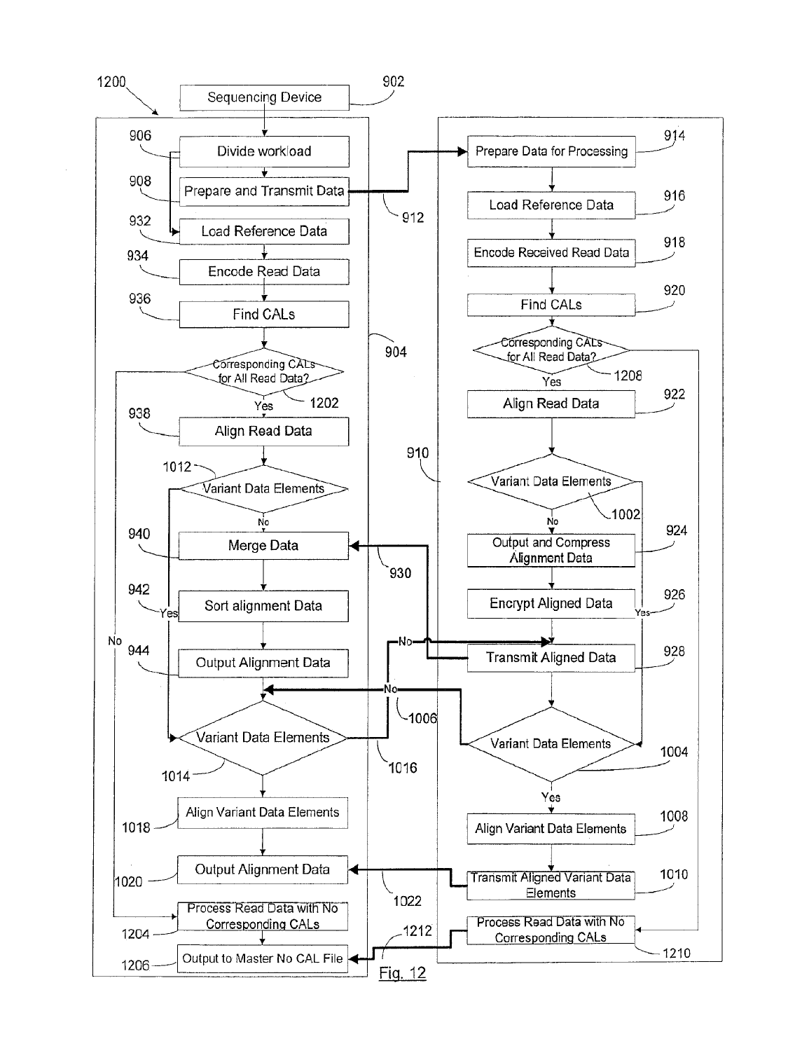

FIG. 12 provides an example of a fast route remote alignment with pre-sorting (“fast remote pre-sort”) process 1200. The fast remote pre-sort process 1200 generally includes similar processes to those discussed in relation to the remote pre-sort process 1000 in FIG. 6. Accordingly, the below description of FIG. 12 discusses only those portions of the process which generally differ from those discussed above relating to FIG. 10.

In the fast remote pre-sort process 1200, the first client 904 can load the reference genome, fast route index, and HASH array of the fast route index at block 932. In one embodiment, the fast route index can be created as discussed above. Once the first client 904 finds a series of CALs at process block 936, the first client 904 can then determine if there are portions of the read data that do not have corresponding CALs at block 1202. If there are no CALs for portions of the read data, that read data can be processed at block 1204. In one embodiment, the portions of the read data with no CALs can be transmitted to a compression engine. The compression engine can apply standard compression techniques to reduce the file size of the read data. Alternatively, the portions of the read data with no CALs can be placed into an electronic file and stored on a memory, such as an external hard disk. The compressed data can then be output to the master no CALs file at block 1206. In one embodiment, the master no CALs file can be located in the first client 1206. Alternatively, the master no CALs file can be located in the second client 910, or another client, as applicable.

The second client 910 can load the reference genome, fast route index, and HASH array of the fast route index at block 916. In one embodiment, the fast route index can be created as discussed above. Once the second client 910 finds a series of CALs at process block 920, the second client 910 can then determine if there are portions of the read data that do not have corresponding CALs at block 1208. If there are no CALs for portions of the read data, that read data can be processed at block 1210. In one embodiment, the portions of the read data with no CALs can be transmitted to a compression engine. The compression engine can apply standard compression techniques to reduce the file size of the read data. Alternatively, the portions of the read data with no CALs can be placed into an electronic file and stored on a memory, such as an external hard disk. The compressed data can then be transmitted to the first client 910 via communication link 1212 and added to the master no CALs file at block 1206.

The present invention has been described in terms of one or more preferred embodiments, and it should be appreciated that many equivalents, alternatives, variations, and modifications, aside from those expressly stated, are possible and within the scope of the invention.

1. A method for transforming a plurality of random biological sequence data to an ordered biological data sequence, the method comprising:
reading a reference biological data sequence;
generating a plurality of indexes based on the reference biological data sequence;
generating a library, the library including the plurality of indexes;
organizing the library into an associative array;
reading the plurality of random biological sequence data;
encoding the plurality of random biological sequence data;
comparing the encoded plurality of random biological sequence data to the reference biological sequence; and
aligning the encoded plurality of random biological sequence data to the reference biological sequence using an alignment algorithm to generate a plurality of alignment data.

2. The method of claim 1, wherein the associative array is a HASH table.

3. The method of claim 1, wherein the random biological sequence data is encoded using a binary mask.

4. The method of claim 3, wherein the binary mask is a gapped binary mask.

5. The method of claim 3, wherein the random biological sequence data is divided into a plurality of k-mers, the length of the plurality of k-mers is equal to the number of non-zero values in the binary mask.

6. The method of claim 5, wherein the associative array indexes the reference biological data sequence as a plurality of j-mers, the length of plurality of j-mers being less than or equal to the length of the plurality of k-mers.

7. The method of claim 1, further comprising converting the encoded plurality of random biological sequence data into a base-4 format

8. The method of claim 1, wherein the encoded plurality of random biological sequence data is compared to the reference data using a candidate alignment location search.

9. The method of claim 1, further comprising generating a directory structure, the directory structure configured to store the plurality of alignment data.

10. The method of claim 9, wherein the directory structure stores the plurality of alignment data in a plurality of individual files.

11. A system for aligning biological sequencing data using a reference biological sequence, the system comprising:
a processing device, the processing device configured to perform executable instructions;
a reader device, the reader device coupled to a sequencing device and configured to read a plurality of data received from the sequencing device;
a quality controller, the quality controller configured to generate one or more parameters indicative of a quality of the plurality of data received from the sequencing device;
a converter, the converter configured to transmute the received data into numerical representations; and
an aligner, the aligner configured to align the plurality of data received from the sequencing device into a single biological sequence using a reference biological sequence.

12. The system of claim 11, the system further comprising a filter, the filter including an index of the reference biological sequence.

13. The system of claim 11, the system further comprising a transmitter, the transmitter configured to transmit the aligned plurality of data.

14. The system of claim 11, wherein the converter transmutes the received data into a base-4 numerical representation.

15. The system of claim 11, wherein the aligner is further configured to execute an optimization algorithm.

16. The system of claim 15, wherein the optimization algorithm is a BLAT-like Fast Accurate Search Tool.

17. The system of claim 15, wherein the processing device is one of a graphics processing unit (GPU), a single core processor, a multi-core processor, a field programmable grid array (FPGA), or an application specific integrated circuit (ASIC).

18. A method for transforming a plurality of random biological sequence data to an ordered biological data sequence using a known reference biological sequence in a first processing device using parallel processing, the method comprising:
reading the plurality of random biological sequence data, the plurality of random biological sequencing data received from a sequencing device;
analyzing the plurality of random biological sequence data and dividing the plurality of random biological sequence data into multiple data portions;
transmitting at least a first portion of the plurality of random biological sequence data to a second processing device;
aligning a second portion of the plurality of random biological sequence data to the reference biological sequence using an alignment algorithm to generate a first plurality of alignment data, the first processing device performing the alignment;
receiving a second plurality of alignment data from the second processing device; and
merging the first plurality of alignment data and the second plurality of alignment data into a sorted order corresponding to the locations of the first plurality of alignment data and the second plurality of alignment data with respect to the reference genome.

19. The method of claim 18, wherein the second processing device aligns the first portion of the plurality of random biological sequence data received from the first processing device to the reference biological sequence using an alignment algorithm to generate the second plurality of alignment data.

20. The method of claim 18, further comprising generating a plurality of indexes based on the reference biological data sequence.

21. The method of claim 20, wherein the indexes include only portions of the reference biological data sequence containing commonly known variations.
